(19) United States
(12) Patent Application Publication
(10) Pub. No.: US 2002/0170849 A1
(43) Pub. Date: Nov. 21, 2002

(54) Manufacture of sodium tripolyphosphate

(76) Inventors: David Krofchak, Copper Cliff (CA); Roberto Berardi, Sudbury (CA)

Correspondence Address: GOWLING LAFLEUR HENDERSON LLP, P.O. Box 1045 LCD1, Hamilton, ON, CA

(21) Appl. No.: 09/859,593

(22) Filed: May 18, 2001

(51) Int. Cl. B03B 1/00; B07B 1/10

(52) U.S. Cl. 209/3; 209/10; 209/11; 209/307

(57) ABSTRACT

A process for producing sodium tripolyphosphate includes mixing sodium hydroxide or sodium carbonate with dilute phosphoric acid in amounts which are substantially stoichiometric for the production of sodium tripolyphosphate to produce an intermediate crystalline mix in a sludge. The intermediate crystalline mix is separated from the sludge, and melted in a vessel to cause sodium tripolyphosphate to be produced. The molten sodium tripolyphosphate is removed from the vessel, and cooled to produce solid sodium tripolyphosphate.

### FIELD OF INVENTION

This invention relates to the manufacture of sodium tripolyphosphate.

### BACKGROUND OF INVENTION

Sodium tripolyphosphate is used in many agricultural, industrial and food applications, for example as a fertilizer component, as a builder in synthetic detergents and as an ingredient in many foods. For such uses, the sodium tripolyphosphate has to be as pure as possible, and various processes for producing sufficiently pure sodium tripolyphosphate are known. Because of the purity requirement, such known processes are relatively expensive.

However, for some uses, it is not necessary for the sodium tripolyphosphate to be particularly pure. For example, U.S. Pat. No. 5,893,463 (Krofchak et al) issued Apr. 13, 1999, U.S. Pat. No. 6,026,965 (Berardi, et al) issued Feb. 22, 2000 and U.S. Pat. No. 6,231,767 (Krofchak et al) issued May 15, 2001 describe processes in which sodium tripolyphosphate is used as a deflocculant. U.S. Pat. No. 5,893,463 relates to the recovery of precious metal particles and small precious stones from aqueous clay suspensions containing such particles in suspension with clay particles. U.S. Pat. No. 6,026,965 relates to the recovery of mineral particles, metal particles over small precious stones from a aqueous slime associate with an ore body or mineral deposit or processing thereof, and U.S. Pat. No. 6,231,767 relates to the treatment of phosphatic waste. The contents of these patents are hereby incorporated herein by reference. The sodium tripolyphosphate used in the processes described in these patents does not have to be particularly pure.

It is therefore an object of the invention to provide a relatively inexpensive process for the manufacture of sodium tripolyphosphate which is suitable for use as a deflocculant in processes such as those referred to above and for other uses which do not require the sodium tripolyphosphate to be particularly pure.

### SUMMARY OF INVENTION

The present invention is based on the discovery that, if sodium hydroxide and/or sodium carbonate are mixed with dilute phosphoric acid in amounts which are substantially stoichiometric for the production of sodium tripolyphosphate to provide an intermediate crystalline mix in a sludge, then sufficiently pure sodium tripolyphosphate can be produced by filtering the intermediate crystalline mix from the sludge, melting the intermediate crystalline mix in a vessel to cause sufficiently pure sodium tripolyphosphate to be produced, removing the molten sodium tripolyphosphate from the vessel, and cooling the molten sodium tripolyphosphate to produce sufficiently pure solid sodium tripolyphosphate. The intermediate crystalline mix may advantageously be melted at the temperature of about 700° C. in the vessel to produce sufficiently pure sodium tripolyphosphate.

A major advantage of the invention is that it can be conveniently carried out at a phosphate mine site where sodium carbonate and/or sodium hydroxide are usually readily available because of use in a beneficiation step such as flotation. Also, dilute phosphoric acid is usually produced in a beneficiation step.

It has been found that sodium tripolyphosphate produced in accordance with the invention is very suitable for use as a deflocculant in processes of the kind referred to earlier.

### DESCRIPTION OF THE DRAWINGS

FIG. 1 is a schematic flow diagram of a process for the production of sodium tripolyphosphate in accordance with one embodiment of the invention, and

FIG. 2 is a diagrammatic view of a process of the kind shown in FIG. 1.

### DESCRIPTION OF PREFERRED EMBODIMENTS

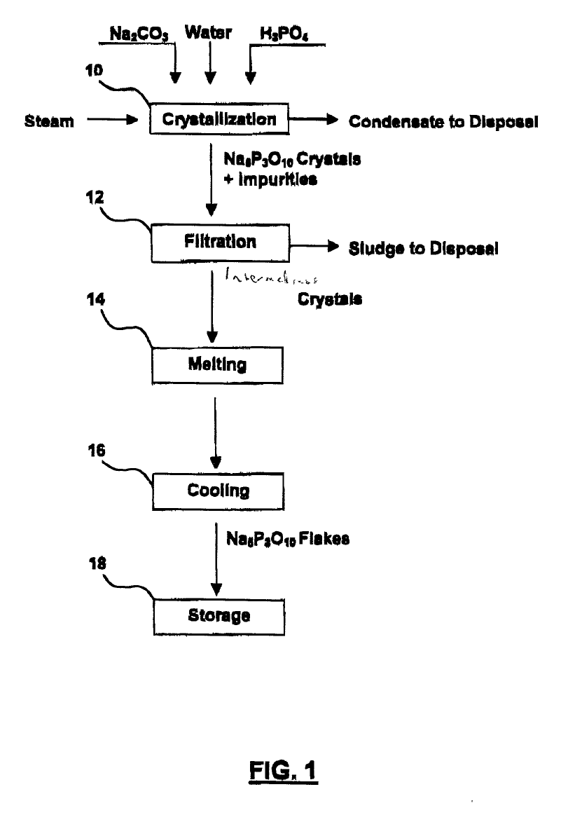

Referring first to FIG. 1 of the accompanying drawings, sodium carbonate, water and dilute phosphoric acid from a phosphate mine (about 64% H₃PO₄) are fed to a crystallization step 10 to which steam is also supplied. The amounts of sodium carbonate and phosphoric acid are such as to produce substantially stoichiometric amounts for the following reaction:

5Na₂CO₃+6H₃PO₄→2Na₅P₃O₁₀+4H₂O+5H₂CO₃

The above reaction is not completed in the crystallization step 10 which actually produces an intermediate crystalline mix of various sodium and phosphate compounds in a sludge. A condensate is passed to the disposal, and the intermediate crystalline mix and sludge are passed to a filtration step 12 from which the sludge is passed to disposal.

The filtered intermediate crystalline mix is passed to a melting step 14 in which the intermediate crystalline mix is melted in a suitable vessel at a temperature of about 700° C. to produce molten sodium tripolyphosphate of relatively good purity.

The molten sodium tripolyphosphate passes to a cooling step 16 where the molten sodium tripolyphosphate is cooled to produce sodium tripolyphosphate flakes, which are then passed to a storage facility 18.

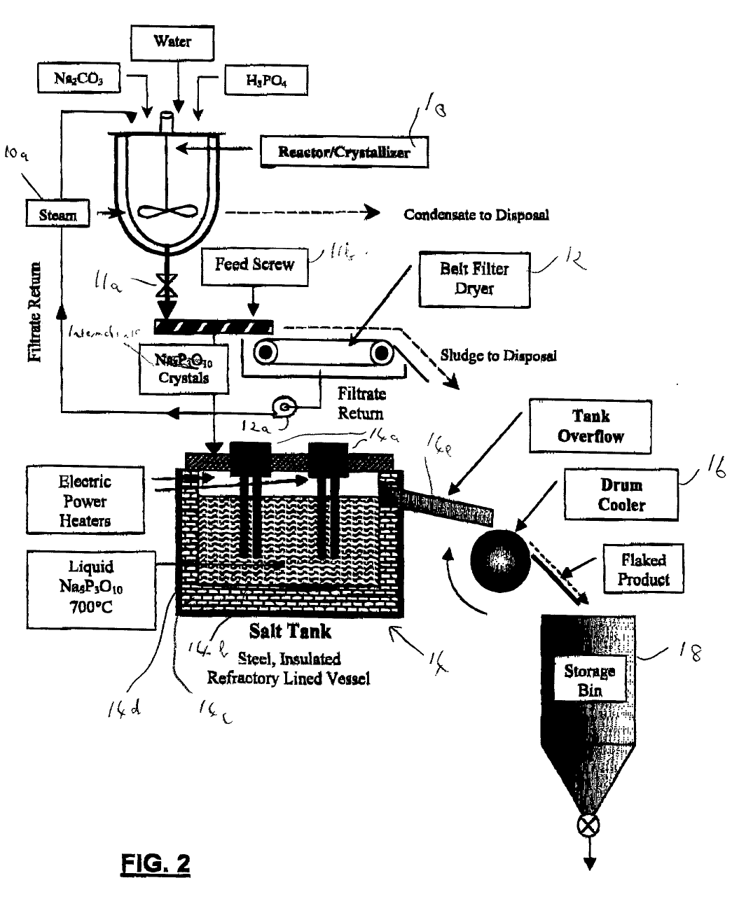

The above described process is illustrated more fully in FIG. 2 where the same reference numerals are used to identify the various steps in the process described above.

The intermediate crystalline mix is formed in a reactor/crystallizer 10 and passed through a valve 11a to a feed screw 11b which delivers the sludge and filtrate to a belt filter dryer 12 which separates sludge from a filtrate which is returned by a pump 12a to the steam supply 10a for the reactor/crystallizer 10. The intermediate crystalline mix is fed from the feed screw 11b to the left hand side of a salt tank 14 where the crystalline mix is heated by electric heaters 14a to about 700° C. to produce molten sodium tripolyphosphate. The salt tank 14 has a heat resistant metal inner lining 14b, insulation 14c and an outer steel casing 14d.

At the right hand side, the salt tank 14 has a heated and insulated overflow pipe 14e to which molten sodium tripolyphosphate leaves the salt tank 14 and flows to a drum cooler 16 which cools the molten sodium tripolyphosphate to a flaked product which is fed to a storage bin 18.

If desired, sodium hydroxide may be used instead of sodium carbonate, the amounts supplied to the reactor/crystallizer 10 being such as to be substantially stoichiometric for the reaction:

5NaOH+3H₃PO₄→Na₅P₃O₁₀+7H₂O

The advantages of the invention will be readily apparent to a person skilled in the art from the above description of preferred embodiments, the scope of the invention being defined in the appended claims.

We claim

1. A process for producing sodium tripolyphosphate including:
mixing at least one compound from the group consisting of sodium hydroxide and sodium carbonate with dilute phosphoric acid in amounts which are substantially stoichiometric for the production of sodium tripolyphosphate to produce an intermediate crystalline mix in a sludge,
separating the intermediate crystalline mix from the sludge,
melting the intermediate crystalline mix in a vessel to cause sodium tripolyphosphate to be produced,
removing the molten sodium tripolyphosphate from the vessel, and
cooling the molten sodium tripolyphosphate to produce solid sodium tripolyphosphate.

2. A process according to claim 1 wherein the intermediate crystalline mix is melted at a temperature of about 700° C. in the vessel to produce sodium tripolyphosphate.
